(19) United States
(12) Patent Application Publication
(10) Pub. No.: US 2021/0200775 A1
(43) Pub. Date: Jul. 1, 2021

(54) NORMALIZING RESOURCE USAGE DATA

(71) Applicant: HEWLETT-PACKARD DEVELOPMENT COMPANY, L.P., Houston, TX (US)

(72) Inventors: Roberto COUTINHO, Rio Grande do Sul (BR); Matheus EICHELBERGER, Rio Grande do Sul (BR); Marcio MARASCHIN, Rio Grande do Sul (BR); Augusto Queiroz de MACEDO, Rio Grande do Sul (BR)

(73) Assignee: HEWLETT-PACKARD DEVELOPMENT COMPANY, L.P., Houston, TX (US)

(21) Appl. No.: 16/077,367

(22) PCT Filed: Mar. 16, 2017
(86) PCT No.: PCT/US2017/022798

§ 371 Date: Aug. 10, 2018

(51) Int. Cl. G06F 16/2457; G06F 11/30; G06F 11/34

(52) U.S. Cl. CPC G06F 16/24578; G06F 11/3495; G06F 11/3089

(57) ABSTRACT

An example method of collecting an n-component subset of resource usage data descriptive of usage of resources of a device or a system includes normalizing a set of resource usage data. Normalizing the set of resource usage data includes comparing usage of a first resource by a first component with usage of the first resource by other components.

### BACKGROUND

For a variety of reasons, there may be a desire to analyze datasets. For example, datasets describing operation of a computing device may be useful for analyzing operation of the computing device, such as to detect improper operation, by way of non-limiting example. For instance, measures of usage of resources of the computing device may be collected and analyzed. Datasets describing human tendencies and behaviors may also be analyzed, such as to provide targeted advertising, for example. As datasets increase in size, they may be referred to as “big data.” In the context of big data, companies, governments, and even individuals, may spend time and resources collecting data and analyzing the collected data. Collection and analysis of large datasets may be challenging, however, such as due to costs and computing resources that may be expended in collection and analysis processes. Additionally, at times, identifying portions of “big data” datasets that may merit analysis may not be readily evident.

### BRIEF DESCRIPTION OF THE DRAWINGS

Various examples will be described below by referring to the following figures.

FIG. 1 illustrates an example system for collecting resource usage data;

FIG. 2 is a flow chart of an example method for collecting resource usage data; and

FIG. 3 illustrates an example system for collecting resource usage data.

### DETAILED DESCRIPTION

In a number of fields, there may be a desire to track resource usage. For example, in the context of a system of networked devices, the networked devices may use their own respective resources (e.g., CPU, memory, battery, etc.) and network resources (e.g., bandwidth, servers, memory, etc.), and there may be a desire to track resource usage in the system. In the context of a computing device or a network, as used herein, a resource refers to a part of the computing device or network that can be used by a program or process while running. For instance, resources of a computing device or network may include a disk drive, a printer, a router, a switch, an access point, a memory, a central processing unit (CPU), a bus, a transceiver, a power source (e.g., a battery), etc. Elevated or unexpected resource usage may indicate an issue at a network node or networked device, by way of illustration. By way of further illustration, in the context of the Internet of Things (IoT), a number of connected devices (e.g., sensors, cameras, HVAC elements, lighting elements, thin devices, etc.) may be arranged at different locations in a home or a workplace and may be in wired or wireless communication with each other and/or a computing device. In this example, there may be a desire to track resource usage of a particular device, such as a sensor, in order to monitor, manage, and maintain the health of the network of connected devices. For ease, a process, application, or device that uses a resource is referred to herein as a component. Thus, a computer application running on a computing device that uses a processor and memory of the computing device is a “component” of the computing device (and of a larger system to which the computing device might belong, such as a network).

In fact, resource usage collection may be relevant in settings outside of the context of a typical computing system or network. For example, collecting indications of resource usage may be desirable for a restaurant where, for example, collecting information as to ingredient usage by food orders may enable analysis of inventory, order trends, etc. Such analysis may help to avoid food spoilage, for example, where too much of a particular ingredient may be ordered compared with actual demand for food orders that use the particular ingredient. As such, in the context of a system, such as a restaurant food inventory system, a resource refers to an asset of the system that may be used or accessed as part of the operation of the system. Thus, for instance, food inventory of a restaurant may be used or accessed in the preparation of dishes for customers of the restaurant. By way of further example, in the context of a system of human resources, such as within a business, it may be desirable to collect a measure of resource usage in terms of access to the human resources in the operation of the business (e.g., such as to determine how well the business balances work among employees, etc.). Thus, in the context of the collection of resource usage data, components can include those elements that might use resources of a system. As such, for example, a component in a system comprising a restaurant may comprise a dish or a plate on the restaurant's menu; in the context of a system of human resources, a component may comprise a department, a manager, a project, or other elements of the business that can occupy an employee's time. Collecting resource usage data, as used herein, refers to collection by a computing device, in which indications of resource usage data are represented in the form of signals or states.

With the foregoing in mind, there is an ever increasing amount of available data as to resource usage, such as to analyze, and it can be challenging to determine which factors may be relevant and/or worth evaluating. For example, on a single computing device it may not be uncommon for hundreds of processes to run in parallel, accessing dozens of resources of the single computing device. In the context of this example, it may be challenging to determine which usage data to analyze or to use in data analytics. There may be a desire, therefore, for a process or device for collecting resource usage data in an efficient manner.

In one example case, a method of collecting resource usage data may comprise normalizing a set of resource usage data, and collecting an n-component subset of the set of resource usage data. As used herein, to normalize data refers processing the data to enable comparison. For instance, in one example, normalizing data values may comprise scaling values to fit in a range from 0 to 1, by way of non-limiting example. To illustrate, if an example device has five resources and 100 components accessing those resources (e.g., programs or processes), it may be possible to normalize the resource usage for each of the 100 components. For instance, a first component may occupy 5% of a CPU consumption and 100 MB of memory, while a second component may occupy 10% of a CPU consumption and 25 MB of memory. In one example case, the usage values for each of the 100 components may be normalized (e.g., scaled to fit in a range from 0 to 1). The normalization of resource usage data may be used, in turn, to rank the components. In one case, a ranking may weight CPU consumption more highly than memory usage, and thus, the second component (10% CPU consumption) may be ranked higher than the first component. In another case, a ranking may weight memory usage more highly than CPU consumption, and thus, the first component (100 MB of memory) may be ranked higher than the second component. A subset of resource usage data may be collected based on the normalized usage values and/or ranking of components. The subset may comprise usage data for n components and may be referred to as an n-component subset. The n-component subset may be determined based on a top-n selection of components that make up a set of resource usage data, where n may be determined as part of a resource usage data collection process, such as by a user. For instance, a user may interact with a user interface (UI) of a computing device and select a number n of components to return.

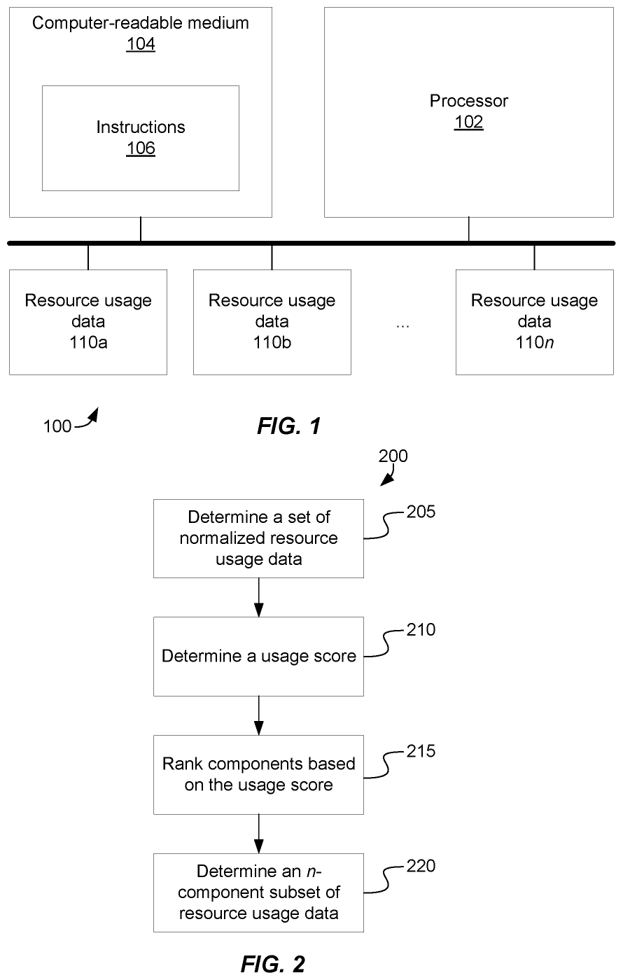

FIG. 1 illustrates an example system 100 for collecting an n-component subset of resource usage data. In one example case, system 100 may comprise instructions 106 stored in a computer-readable medium 104, and instructions 106 may, when executed by a processor, such as processor 102, enable collection of an n-component subset of resource usage data. Processor 102 may comprise a suitable processing mechanism, such as a central processing unit (CPU) of a computing device, a field-programmable gate array (FPGA), or an application-specific integrated circuit (ASIC), by way of non-limiting example. Computer-readable medium 104 may comprise a mechanism for storing signals or states, such as random access memory (RAM), read only memory (ROM), magnetic, flash, or phase change memory, by way of non-limiting example. Instructions 106 may comprise code or instructions for a routine or algorithm in a number of possible syntaxes. Instructions 106 may include, by way of non-limiting example, executable code to enable processor 102 to, among other things, normalize and collect resource usage data. The present disclosure includes a sample flow chart, FIG. 2, in conjunction with which discussion is provided of example operation of computing devices, such as may be enabled by instructions 106, to normalize and collect resource usage data.

Computer-readable medium 104, instructions 106, and processor 102 may be part of a single computing device or may be spread out across multiple computing devices, such as part of a distributed computing network (e.g., Hadoop). FIG. 1 illustrates computer-readable medium 104, instructions 106, and processor 102 communicably coupled, such as via a bus of a device, a network connection, or other possible communication mechanisms capable of enabling exchange of signal packets.

FIG. 1 also includes resource usage data 110a-110n representing n sets of data related to resource usage. In one example, each of resource usage data 110a-110n may represent data received from different components of system 100. For example, resource usage data 110a may come from a first component or a first device (e.g., a first collection of components); resource usage data 110b may come from a second component or a second device (e.g., a second collection of components); and resource usage data 110n may come from an nth component or an nth device (e.g., an nth collection of components). Resource usage data 110a-110n may be received over a wired or wireless communications channel and stored in computer-readable medium 104 and/or processed (e.g., normalized) by processor 102. As noted above, example operation of FIG. 1 will be discussed hereinafter in reference to example method 200 of FIG. 2.

FIG. 2 illustrates an example method 200 for collecting an n-component subset of resource usage data. In discussing example method 200, reference is made to elements of example system 100 FIG. 1. At a block 205, a set of resource usage data may be normalized, such as a set received from another device. By way of example, resource usage data 110a-110n may be received by example system 100. Executable instructions, such as instructions 106, for normalizing sets of resource usage data, such as resource usage data 110a-110n, may be fetched and executed by processor 102. Responsive to execution of instructions 106, a method for normalizing may run, receive a set of resource usage data, and output a normalized set of resource usage data. One non-limiting example normalizing method is discussed in the following paragraphs.

TABLE 1

| | CPU time | | Memory | Time |
|---|---|---|---|---|
| Components | (sec.) | CPU % | (MB) | (sec) |
| Comp. 1 | 60 | 1 | 105 | 280 |
| Comp. 2 | 80 | 5 | 100 | 600 |
| Comp. 3 | 20 | 0.5 | 40 | 1800 |
| Comp. 4 | 5 | 0.1 | 25 | 1800 |
| Comp. 5 | 150 | 3 | 110 | 900 |

Table 1 includes sample values, such as may be included in resource usage data (e.g., resource usage data 110a-110n), for five example components, components 1-5. Thus, in one example, usage of a CPU resource may be measured in terms to a time during which a component accesses the CPU resource (e.g., CPU time) or in terms of a percentage of the CPU that a component is using (e.g., CPU %), by way of non-limiting example. Usage of a memory resource may be measured in terms of memory used by a component, a maximum amount of physical memory that a component has used (e.g., peak memory), by way of non-limiting example. And time refers to an amount of time that a component has been running and may be indicative of use of CPU and memory usage, by way of example. Of course, these are but examples of resources that may be used and possible measures of resource usage, and are not to be taken in a limiting sense. Several sample resources are listed below in Table 3 by way of non-limiting illustration. These components may comprise processes running on a computing device, by way of non-limiting example.

In one example, the values in Table 1 may be normalized using an expression, such as the following:

$$normalized value = \frac{( x - minValue )}{( maxValue - minValue )} \qquad ( 1 )$$

where:
x refers to a resource usage value for a component,
minValue refers to a smallest value for a resource for all components in the set of resource usage data, and
maxValue refers to a largest value for a resource for all components in the set of resource usage data.

Thus, for example, a normalized value for CPU time of component 1 in Table 1 may be determined as follows:

$$normalized value = \frac{( 60 - 5 )}{( 150 - 5 )} = \frac{55}{145} \approx 0.38$$

A normalized value for CPU % of component 1 may be determined as follows:

$$normalized value = \frac{( 1 - 0.1 )}{( 5 - 0.1 )} = \frac{0.9}{4.9} \approx 0.18$$

A normalized value for memory used by a method may be determined as follows:

$$normalized value = \frac{( 105 - 25 )}{( 110 - 25 )} = \frac{80}{85} \approx 0.94$$

And a normalized value for a time that a component has been running may be determined as follows:

$$normalized value = \frac{( 280 - 280 )}{( 1800 - 280 )} = 0$$

Continuing with this example normalization method, the remaining values of Table 1 may be normalized to yield the approximated values in Table 2. As should be apparent, this normalization method may yield values from 0 to 1, inclusive. It is to be understood that this discussion is presented merely to illustrate one possible normalization method and is not to be taken in a limiting sense. Indeed, a number of possible normalization methods may exist and may be used to yield a normalized set of resource usage data using a number of possible measures of resource usage.

TABLE 2

| | CPU | | | | Usage |
|---|---|---|---|---|---|
| Components | timeₙₒᵣₘ | CPU %ₙₒᵣₘ | Memoryₙₒᵣₘ | Timeₙₒᵣₘ | score |
| Comp. 1 | 0.38 | 0.18 | 0.94 | 0 | 3.38 |
| Comp. 2 | 0.52 | 1 | 0.88 | 0.21 | 5.43 |
| Comp. 3 | 0.10 | 0.08 | 0.18 | 1 | 1.32 |
| Comp. 4 | 0 | 0 | 0 | 1 | 0.5 |
| Comp. 5 | 1 | 0.59 | 1 | 0.41 | 6.39 |

As resource usage data is normalized, a number of components may be used to select an n-component subset of resource usage data to collect, such as by writing the n-component subset to a memory. For instance, in one case, a subset of component resource usage values may be written to a memory responsive to a determination that a threshold (e.g., CPU % usage, memory usage, etc.) has been exceeded. For instance, in one case, thresholds may be set, such as to CPU % or Memory usage, using, for instance, normalized values of 0.75 and higher, by way of non-limiting example. And component resource usage values may be collected for components with normalized values exceeding the thresholds. Using such an approach, and looking at CPU time, CPU %, and Memory, component resource usage data may be collected (e.g., written to a memory) for components 1, 2, and 5.

Another example method for collecting an n-component subset of resource usage data may include scoring components, such as based on resource usage by components. For instance, in one sample case, a usage score may be determined based, for instance, on a usage expression, such as illustrated at block 210 of example method 200. A usage score may be based on normalized resource usage values in one example case. Normalized resource usage values may be weighted to provide more weight to certain factors, by way of example. Usage expressions may be changed to suit a particular context. For instance, in the context of the resource usage data provided in Tables 1 and 2, a sample usage expression may comprise:

(3×CPU timeₙₒᵣₘ)+(2×CPU %ₙₒᵣₘ)+(2×Memoryₙₒᵣₘ)+(0.5×Timeₙₒᵣₘ)

where ‘3,’ ‘2,’ ‘2,’ and ‘0.5’ are example weighting values. Using this usage expression on the resource usage values from Table 2 yields usage scores of 3.38, 5.43, 1.32, 0.50, and 6.39, respectively, for components 1-5. Other resource usage expressions may be based on portions (e.g., classes of usage data) of resource usage data, without limitation. For instance, another example usage expression may include one or more of the following example measures of resource usage in Table 3, by way of example.

TABLE 3

| Example resource | Description |
|---|---|
| CPU % | Percent of CPU consumption by component |
| CPU time | Aggregate time that component uses CPU |
| Memory | Measure of physical memory used by component |
| Peak memory | Measure of largest of physical memory used by |
| | component at a time |
| Time | Measure of time that a component has been using |
| | resources (e.g., running) |
| I/O Writes | Number of I/O write events by component |
| I/O Reads | Number of I/O read events by component |
| I/O Write bytes | Measure of bytes written in I/O by component |
| I/O Read bytes | Measure of bytes read in I/O by component |

In cases in which a usage score is used to collect an n-component subset of resource usage values, collection of the n-component subset may include ranking components based on normalized resource usage values, resource usage scores, or a combination thereof. For instance, resource usage values for components of a device or system may be ranked, using the determined usage scores, such as illustrated at block 215 of example method 200. Using the example usage scores determined above (3.38, 5.43, 1.32, 0.50, and 6.39), components 1-5 of Tables 1 and 2 may be ranked in the following order: 5, 2, 1, 3, and 4. In one case, and as illustrated at block 220 of example method 200, resource usage values for an n-component subset of resource usage data may be determined and collected, such as based on usage ranking values. For instance, in one example case, using the example ranking and usage above, the top-3 components (e.g., components 5, 2, and 1) may be collected, such as by being written to a memory. A value for n may be based on user parameters (e.g., a user may specify returning top-3 component values, such as via a user interaction with a UI) or physical constraints (e.g., limitations as to memory, processing, bandwidth, etc.), among other things. By way of further example, a threshold usage score value may be set (e.g., 4) and component resource usage values may be returned for components with usage scores greater than (or equal to, in some cases) the usage score. In the case of a threshold usage score of 4, the collected n-component resource usage data may comprise components 2 and 5 as they are the components with usage scores greater than 4, in this non-limiting example.

To illustrate how example method 200 might work in one example context, an example use case for collection of resource usage on a private network may be considered. In this case, hundreds of devices may be present on the private network and it may be desirable to collect a subset of resource usage data for network and computing device resources. For example, it may be desirable to determine whether computing devices on the private network are potentially using unusual or unexpected amounts of resources (e.g., using unexpected and/or prolonged amounts of CPU or memory). It may also be desirable to determine whether some computing components are using unusual or unexpected levels of network resources (e.g., using unexpected amounts of bandwidth).

Thus, for example, values indicative of resource usage for different components of the private network may be normalized, such as using expression (1), above. The values may be in the form of signals and states transmitted between devices in the form of digital or analog data, for instance. And the data may be processed, such as based on expression (1). A usage score may be determined for the components of the private network. For example, a weighted sum of normalized resource usage data may be used to yield resource usage scores for the components of the private network. Components of the private network may be ranked based on the determined usage scores. The ranking of components may be used to yield an n-component subset of resource usage data for collection.

In one case, an n value representing a number n of component resource usage data to collect may be specified, and an n-component subset of resource usage data (e.g., a top-10 subset) for the private network may be collected, such as by being written to a memory. The n value may vary to yield larger or smaller n-component subsets to collect, for example. In another sample case, a usage score threshold may be set and an n-component subset of resource usage data may be collected (e.g., written to a memory) corresponding to those components having a usage score exceeding the threshold.

Another example use case for using example method 200 to collect an n-component subset of resource usage data may comprise a system of devices used for web hosting. For example, it may be desirable to track memory, CPU, and bandwidth usage for a system of device that hosts websites using shared resources (e.g., shared servers, shared hard drives, etc.). Values indicative of memory, CPU, and bandwidth usage may be normalized, such as using expression (1), consistent with block 205. The normalized usage values may be used to yield usage scores, such as consistent with block 210. For example, in a case in which the usage values may be of equal concern, an unweighted usage score expression may be used, such as:

$$usage score = {Memory}_{norm} + CPU {\%}_{norm} + {BandwidthUp}_{norm} + {BandwidthDn}_{norm}$$

where Memoryₙₒᵣₘ refers to a normalized memory usage value, CPUₙₒᵣₘ refers to a normalized CPU % usage value, BandwidthUpₙₒᵣₘ refers to bandwidth in terms of signal packets sent by a component, and BandwidthDnₙₒᵣₘ refers to bandwidth in terms of signal packets received by the component. In another example, normalized usage values may be weighted in determining a usage score.

Component resource usage data may be ranked using determined usage scores, such as consistent with block 215. A top-n component subset of resource usage values may be collected and written to a memory using determined usage scores, such as consistent with block 220 of FIG. 2. For example, in one case, it may be determined that of the potentially thousands of components using resources of the shared hosting network of devices, a top-100 subset should be collected, such as to allow analysis of resource usage.

In view of the foregoing, it should be understood that collection of resource usage data may be relevant to a number of possible contexts and claimed subject matter should be not limited by the examples provided herein.

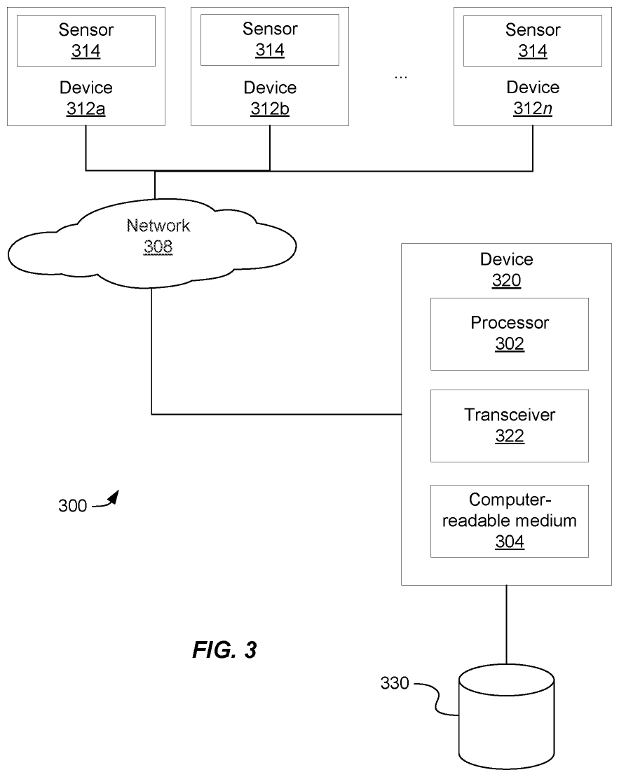

FIG. 3 illustrates an example system 300 comprising a device 320 having a processor 302, a transceiver 322, and a computer-readable medium 304. Processor 302 and computer-readable medium 304 may be similar to processor 102 and computer-readable medium 104 of FIG. 1, respectively, discussed above. Transceiver 322 may comprise a suitable mechanism of device 320 capable of sending and receiving signal packets. For instance, transceiver 322 may comprise a wireless radio transceiver (e.g., 3G, LTE, WIFI, BLUETOOTH, etc.) or a wired transceiver (e.g., an Ethernet card, a modem, etc.), or other suitable mechanism for sending and receiving signal packets.

As illustrated, device 320 may be communicably coupled, via a network 308, to a plurality of devices, devices 312a-312n. Devices 312a-312n comprise a sensor 314. Sensor 314 may comprise a mechanism capable of detecting events or changes in an environment surrounding sensor 314 (e.g., detecting sound, electromagnetic radiation, current and changes in current, etc.). For instance, sensor 314 may comprise a light sensor, an IR sensor, a sound sensor, or an analyte sensor, by way of non-limiting example. Device 320 may also be communicably coupled to a storage element 330, which may comprise a database or other suitable mechanism for storing resource usage data. Example system 300 may comprise, for example, a home or office alarm and automation system having a number of devices with sensors communicably coupled over a network. Device 320 may comprise a computing device capable of monitoring devices of system 300. For instance, device 320 may comprise a control panel for managing an IoT system, and may be capable of transmitting signal packets to and receiving signal packets from a remote device or system (e.g., computing devices at a service provider). In one such case, it may be desirable to send a subset of resource usage data, rather than transmitting an entire set of resource usage data, for example. Consequently, using a resource usage data collection method, such as example method 200, for collecting a subset of resource usage data may be desirable.

Devices 312a-312n may comprise devices capable of receiving and transmitting signal packets to and from device 320. Sample signal packets may contain data based on readings at a sensor, such as sensor 314, of devices 312a-312n. For example, devices 312a-312n may comprise motion detection sensors, glass break sensors, light sensors, temperature sensors, or leak sensors, among other things, and may have the capacity to interact with other devices in a home or office, such as HVAC monitor/control components or light controllers, among other things.

In one example, devices 312a-312n may have a power source resource (e.g., a battery) that may lose charge over time. In such cases, devices 312a-312n may be capable of transmitting signals indicative of power source charge level to device 320. Thus, resource usage data indicative of power source charge level, rate of discharge, etc. may be transmitted to device 320 for collection, such as consistent with example method 200. By way of further example, indications of network usage (e.g., bandwidth, transmission packet size, frequency, etc.) may also be collected by device 320.

In operation of example system 300, device 320 may receive signals and/or states from devices 312a-312n indicative of resource usage by components of devices 312a-312n. In one example, device 320 may be referred to as a collection device due to its capability to receive signals indicative of resource usage data. Received resource usage data may be normalized, such as consistent with the above discussion of block 205 of FIG. 2. For instance, in one example case, expression 1 may be used to normalize the received resource usage data. Consistent with block 210 of FIG. 2, resource usage scores may be determined for components of example system 300. Example resource usage scores may take battery usage, processor usage, and bandwidth into account in determining a score to quantify resource usage to enable comparison of resource usage, for example.

Consistent with block 215 of FIG. 2, components of example system 300 may be ranked. For example, it may be determined that a motion sensing process running on a motion sensor (e.g., device 312a) may be using more battery resources, processing resources, and/or network resources (e.g., bandwidth) than similar components on other devices (e.g., devices 312b and 312n). Thus, the motion sensing process may be ranked higher than other components of system 300. Potentially unexpected resource usage data may be indicative of a problem with a device, by way of example. For instance, a device may have been hacked, it may be operating incorrectly, such as not going to sleep when expected, and thus, it may be desirable to analyze a particular component based on collected resource usage data. However, as noted above, identifying resource usage data worthy of analysis can be challenging at times. Thus, by normalizing resource usage data, determining resource usage scores, and ranking components based on the usage scores, it may be possible to determine a subset of resource usage data to collect, such as discussed above in relation to block 220 of example method 200.

As should be apparent, normalizing a set of resource usage data and collecting an n-component subset of resource usage data may be desirable, such as to provide a more efficient way to collect resource usage data and provide analysts a more manageable data set, by way of example.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A non-transitory computer-readable medium comprising computer-executable instructions that when executed cause a processor of a computing device to:
normalize a received set of resource usage data based on a comparison of usage of a first resource by a first component of a device or a system with usage of the first resource by other components of the device or the system, wherein the received set of resource usage data is indicative of resource usage by a plurality of components accessing a plurality of resources of the device or the system; and
write, to a memory of the computing device, an n-component subset of resource usage data based on a comparison of values of the normalized resource usage data, the n-component subset of resource usage data comprising a top-n selection of the plurality of components accessing the plurality of resources of the device or the system.

2. The non-transitory computer-readable medium of claim 1, further comprising instructions to:
determine usage scores based on the normalized set of resource usage data; and
rank components of the plurality of components based on a comparison of the usage scores.

3. The non-transitory computer-readable medium of claim 2, wherein the n-component subset of resource usage data is based on the ranked components of the plurality of components.

4. A collection device comprising:
a transceiver; and
a processor communicably coupled to the transceiver, the processor to:
receive from a plurality of devices, via the transceiver, a set of resource usage data indicative of resource usage by a plurality of components accessing a plurality of resources of the plurality of devices;
determine a set of normalized resource usage data based on a comparison of usage of a first resource by a first component with usage of the first resource by other components; and
collect, to a non-transitory computer-readable storage medium of the collection device, an n-component subset of resource usage data comprising a top-n selection of the plurality of components accessing the plurality of resources of the plurality of devices.

5. The collection device of claim 4, wherein the plurality of devices comprise sensors.

6. The collection device of claim 5, wherein the sensors measure characteristics of an environment.

7. The collection device of claim 4, wherein the n-component subset of resource usage data is aggregated by a device of the plurality of devices and received by the collection device periodically.

8. The collection device of claim 4, further wherein the processor is further to perform analytics of a system comprising the plurality of devices using the collected n-component subset of resource usage data.

9. The collection device of claim 4, wherein to determine the set of normalized resource usage data is to comprise determination of a ratio comprising a difference between usage of the first resource by the first component and usage of the first resource by a second component compared with a difference between usage of the first resource by a third component and the usage of the first resource by the second component.

10. A method at a device for collecting resource usage data, the method comprising:
receiving a set of resource usage data indicative of resource usage by a plurality of components accessing a plurality of resources of a device or a system;
determining, by a processor, a set of normalized resource usage data based on a ratio comprising a difference between usage of a first resource by a first component and usage of the first resource by a second component compared with a difference between usage of the first resource by a third component and the usage of the first resource by the second component;
determining, by a processor, a usage score based on the set of normalized resource usage data; and
collecting, to a non-transitory computer-readable storage medium, an n-component subset of resource usage data comprising a top-n selection of the plurality of components accessing the plurality of resources of the device or the system.

11. The method of claim 10, wherein the usage score comprises a weighted sum of normalized resource usage data for the first component.

12. The method of claim 10, wherein collecting the n-component subset of resource usage data comprises collecting usage data for components having the determined usage score above a threshold.

13. The method of claim 10, wherein collecting the n-component subset of resource usage data is based on a subset of the plurality of resources identified responsive to a user interaction.

14. The method of claim 13, wherein metric values indicative of the subset of the plurality of resources comprise central processing unit (CPU) usage percentage, CPU time, memory, peak memory, time running, I/O writes, I/O reads, I/O write bytes, I/O read bytes, battery usage, battery charge level, or a combination thereof.

15. The method of claim 10, wherein the set of resource usage data is received from a plurality of sensors.
